(19) United States
(12) Patent Application Publication
(10) Pub. No.: US 2019/0120316 A1
(43) Pub. Date: Apr. 25, 2019

(54) VIBRATION REDUCTION STRUCTURE

(71) Applicants: Hyundai Motor Company, Seoul (KR); Kia Motors Corporation, Seoul (KR); Ajou University Industry-Academic Cooperation Foundation, Suwon (KR)

(72) Inventors: Kyoung Jin Chang, Suwon (KR); Jin Woo Lee, Suwon (KR); Jaewoong Jung, Suwon (KR); Jong Kyeom Lee, Suwon (KR)

(21) Appl. No.: 15/834,654

(22) Filed: Dec. 7, 2017

(30) Foreign Application Priority Data
Oct. 24, 2017 (KR) 10-2017-0138365

(51) Int. Cl. F16F 7/104; B62D 25/06; B62D 25/08; G10K 11/162

(52) U.S. Cl. CPC F16F 7/104; G10K 11/162; B62D 25/081; B62D 25/06

(57) ABSTRACT

A vibration reduction structure is provided. The vibration reduction structure includes a vibration reduction unit that is configured to reduce vibration or noise generated and transmitted to a plate member including a main aperture with a predetermined shape. The vibration reduction unit includes a main aperture that is formed in a predetermined shape in the plate member. A mass member has a predetermined shape and a predetermined thickness and is disposed in the main aperture. A connecting member is configured to integrally connect the plate member and the mass member.

### CROSS-REFERENCE TO RELATED APPLICATION

This application claims priority to and the benefit of Korean Patent Application No. 10-2017-0138365 filed on Oct. 24, 2017, the entire contents of which are incorporated herein by reference.

### BACKGROUND

### Field of the Disclosure

The present disclosure relates to a vibration reduction structure, and more particularly, to a vibration reduction structure for reducing vibration or noise energy transmitted to a first side of a panel of a vehicle body from being transmitted to a second side.

### Description of the Related Art

Generally, a dash panel formed in a diving wall is disposed between an engine compartment and passenger compartment of a vehicle. A floor panel configuring a bottom surface is disposed toward a rear side of a vehicle body from a lower end of the dash panel. An acoustic absorbing material and a sound insulation material are sequentially stacked on and coupled to a conventional dash panel and floor panel to reduce or insulate sound transmitted from an engine compartment and road noise transmitted from the ground.

However, when an acoustic absorbing material and a sound insulation material are used to create a substantial thickness on a dash panel, a floor panel, etc., noise is significantly reduced but noise reduction is limited by the associated increased manufacturing costs and increased vehicle weight. Accordingly, a method of reducing noise transmitted into a vehicle from an external source or an engine is needed. Research has been conducted to reduce noise or vibration transmitted through a cowl disposed between an interior cavity and an engine compartment of a vehicle, a cowl top panel disposed above the cowl to correspond to a hood, a roof panel of a vehicle body, etc.

The above information disclosed in this section is merely for enhancement of understanding of the background of the disclosure and therefore it may contain information that does not form the prior art that is already known in this country to a person of ordinary skill in the art.

### SUMMARY

The present disclosure provides a vibration reduction structure having advantages of changing a shape of a plate member to which vibration or noise is transmitted instead of a separate acoustic absorbing material or sound insulation material and reducing vibration or noise input to a first side from being transmitted to a second side. Accordingly, the vehicle weight increase may be minimized and manufacturing costs may be reduced.

In an aspect of an exemplary embodiment of the present disclosure a vibration reduction structure may include a vibration reduction unit configured to reduce vibration or noise generated and transmitted to a plate member having a main aperture with a predetermined shape. The vibration reduction unit may include a mass member having a predetermined shape and a predetermined thickness and may be disposed in the main aperture, and a connecting member formed to integrally connect the plate member and the mass member. An area of the main aperture may be greater than an area of the mass member.

In some exemplary embodiments, a thickness of the plate member may be equal to a thickness of the connecting member. A thickness of the mass member may be greater than a thickness of the plate member or the connecting member. The plate member may further include an auxiliary aperture disposed adjacent to the main aperture. The connecting member may be inclined toward the auxiliary aperture from a virtual central line that passes through a central portion of a aperture of the main aperture.

In other exemplary embodiments, an edge of the mass member may be disposed along a first interior surface of the plate member with the main aperture formed therein. A sub gap with a predetermined length may be disposed between a lateral surface of the connecting member and a lateral surface of the mass member. The vibration reduction unit may be disposed on the plate with a predetermined interval.

The plurality of main apertures may be disposed on the plate member with a predetermined interval and the auxiliary apertures may be disposed on the plate member to correspond to the plurality of main apertures with a predetermined interval, respectively. The main aperture and the auxiliary aperture may have a quadrangular shape.

Additionally, an external surface of the mass member facing a first interior surface of the plate member with the main aperture formed therein may be formed with a predetermined gap. The vibration reduction unit may be disposed in a direction in which the vibration or noise is transmitted. The plate member may be a roof panel of a vehicle body. The plate member may be a cowl or a cowl top panel in a vehicle body.

According to an exemplary embodiment of the present disclosure, a vibration reduction structure may include a structure in which radiated noise is generated to effectively prevent vibration and noise from being transmitted in a radiated noise frequency band. A basic shape of a vibration reduction structure for altering vibration characteristics of a structure may be proposed and radiated noise and vibration may be effectively reduced. A vibration reduction structure may be formed to uniformly dispose vibration reduction units with the same shape in a direction that the vibration waves are transmitted, an arbitrary noise reduction period may be selected and oppositely, a structure for reducing noise in a desired frequency band may be designed.

A dimension of a shape of a vibration reduction unit may be adjusted to eliminate a wave number in a desired frequency band in which radiated noise reduction is intended. In addition, the vibration reduction unit for reducing the generated vibration may absorb vibration energy input to an entire structure to reduce vibration and noise of the structure in the corresponding frequency band.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an exemplary perspective view of a portion of a vibration reduction structure according to an exemplary embodiment of the present disclosure;

FIG. 2 is an exemplary perspective view showing a state in which a vibration reduction structure is arranged according to an exemplary embodiment of the present disclosure;

FIG. 3 is an exemplary graph showing a vibration reduction period in which a vibration reduction structure absorbs vibration according to an exemplary embodiment of the present disclosure;

FIG. 4 is an exemplary graph showing a noise reduction effect of a vibration reduction structure according to an exemplary embodiment of the present disclosure;

FIGS. 5A and 5B are an exemplary perspective view showing a noise reduction effect of a vibration reduction structure according to an exemplary embodiment of the present disclosure;

FIG. 6 is an exemplary graph showing a vibration reduction period in which a vibration reduction structure absorbs vibration according to an exemplary embodiment of the present disclosure;

FIG. 7 is an exemplary graph showing a noise reduction effect of a vibration reduction structure according to an exemplary embodiment of the present disclosure; and

FIG. 8 is an exemplary top plan view showing a vibration reduction structure according to another exemplary embodiment of the present disclosure.

### DETAILED DESCRIPTION

In the following detailed description, only certain exemplary embodiments of the present disclosure have been shown and described, simply by way of illustration. Sizes and thicknesses of the elements shown in the drawings are for the purpose of descriptive convenience, and thus the present disclosure is not necessarily limited thereto. Thicknesses of layers and regions are expanded in the drawings for clarity. To clearly describe the present disclosure, a part without concerning to the description is omitted in the drawings, and like reference numerals in the specification denote like elements. Throughout the specification, although the terms first, second, etc. may be used herein to describe various elements, these elements should not be limited by these terms.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A vibration reduction structure according to an exemplary embodiment of the present disclosure may be selectively applied to a cowl, a cowl top panel, a roof panel, or the like of a vehicle body and may be applied to any part of the vehicle body. The vibration reduction structure may be applied to an interior panel or support of an electronic product (e.g., a washing machine, a refrigerator, a dish washer, a microwave, an air conditioner, or a hot blast heater) and may reduce vibration or noise transmitted from a rotor (e.g., a motor) and a compressor.

The vibration reduction structure may be applied to a support or stiffener for supporting a noise barrier of a road or a storm drain of a building and may be applied to a device for performing milling, cutting, extruding, and molding to reduce noise and vibration. The vibration reduction structure may be applied to a support and a housing of a rotor device (e.g., a pump, a compressor, and a turbine of an electric power station), may be applied to a support of a hard disk of a computer, or may be applied to a computer main body case to reduce vibration and noise transmitted from a cooling fan and to simultaneously, increase air circulation efficiency and may be applied to various electronic devices to reduce noise and vibration generated from the devices.

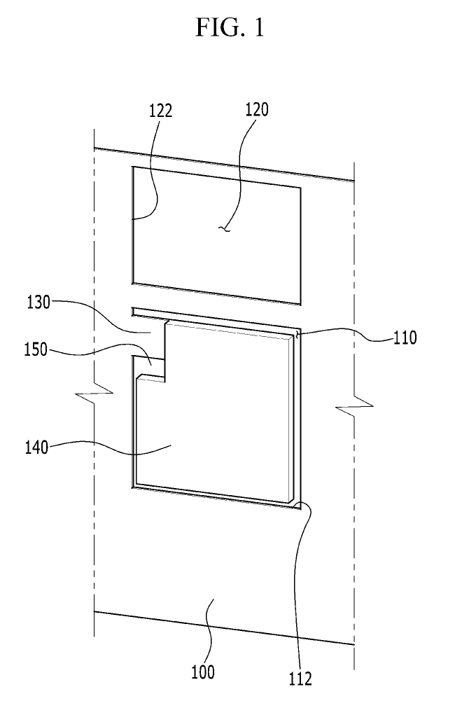

FIG. 1 is an exemplary perspective view of a portion of a vibration reduction structure according to an exemplary embodiment of the present disclosure. Referring to FIG. 1, the vibration reduction structure may include a plate member 100, a main aperture 110, a connecting member 130, a mass member 140, a sub gap 150, an auxiliary aperture 120, a first interior surface 112, and a second interior surface 122.

According to an exemplary embodiment of the present disclosure, the plate member 100 may be a roof panel (not shown) as a portion of a vehicle body and may be a cowl top panel disposed above a cowl of an engine compartment. The plate member 100 may be applied to any device to which vibration and noise are transmitted as well as a portion of a vehicle body, to which vibration and noise are transmitted. The main aperture 110 with a quadrangular shape may be formed in a first side of the plate member 100. The mass member 140 may be disposed within the main aperture 110 and the connecting member 130 may be integrally formed with the plate member 100 and the mass member 140.

The mass member 140 may be formed along the first interior surface 112 of the main aperture 110 except for the connecting member and the sub gap 150 with a predetermined length may be formed between a lateral surface of the connecting member 130 and a lateral surface of the mass member 140. The auxiliary aperture 120 may be formed above the main aperture 110, the auxiliary aperture 120 may have a rectangular shape similar to the shape of the main aperture 110, and the connecting member 130 may be inclined toward the auxiliary aperture 120 in the main aperture 110. Accordingly, the sub gap 150 may be formed at a first side and the auxiliary aperture 120 may be disposed at a second side based on the connecting member 130.

According to the present disclosure, the connecting member 130 and the plate member 100 may be formed to have the similar thickness and the mass member 140 may be formed to have a greater thickness than the connecting member 130. According to an exemplary embodiment, a length and width of the main aperture 110, a length, width and thickness of the connecting member 130, a length, width and thickness of the mass member 140, a length, width and thickness of the sub gap 150, and a length and width of the auxiliary aperture 120 may be changed based on a design specification. According to an exemplary embodiment, an external surface of the mass member 140 disposed to face the first interior surface 112 of the plate member 100 with the main aperture 110 formed therein may be formed with a predetermined gap.

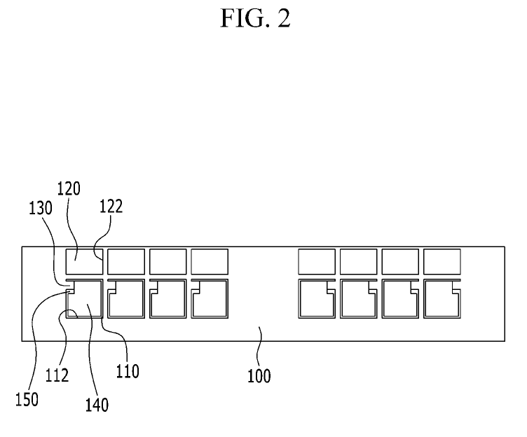

FIG. 2 is an exemplary perspective view showing a vibration reduction structure disposed according to an exemplary embodiment of the present disclosure. Referring to FIG. 2, the main aperture 110, the mass member 140, connecting member 130, and the auxiliary aperture 120 may be considered as one vibration reduction unit and the vibration reduction unit may be disposed with a predetermined interval in a direction that the vibration and noise are transmitted. Accordingly, the generated vibration and noise may be more effectively reduced.

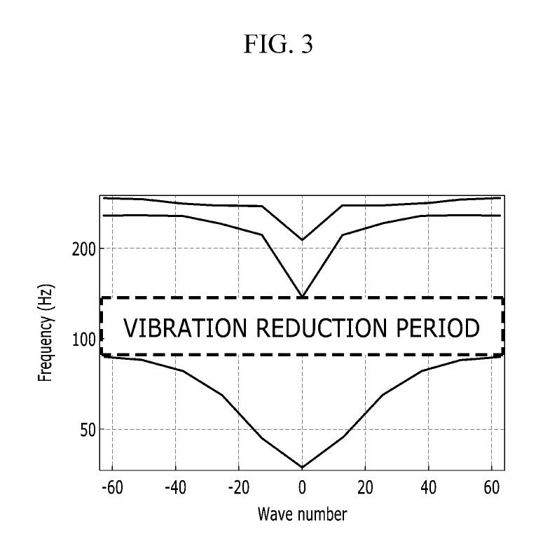

FIG. 3 is an exemplary graph showing a vibration reduction period having a vibration reduction structure that absorbs vibration according to an exemplary embodiment of the present disclosure. Referring to FIG. 3, a horizontal axis indicates a wave number, a vertical axis indicates a frequency, and a vibration reduction period may be a frequency of about 90 to 140 according to a design specification. For example, the vibration reduction period may be adjusted based on shape characteristics (e.g., a length, a width, a thickness, a shape, etc.) of the connecting member 130, the mass member 140, the main aperture 110, and the auxiliary aperture 120.

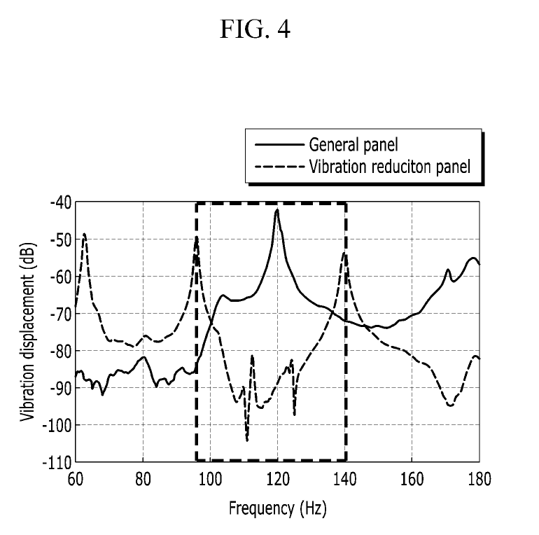

FIG. 4 is an exemplary graph showing a noise reduction effect of a vibration reduction structure according to an exemplary embodiment of the present disclosure. Referring to FIG. 4, a horizontal axis indicates a frequency and a vertical axis indicates vibration displacement. When a frequency is in a range of about 90 Hz to 140 Hz, vibration displacement may be mostly high in a general panel and vibration displacement may be mostly low in a noise reduction panel according to an exemplary embodiment of the present disclosure.

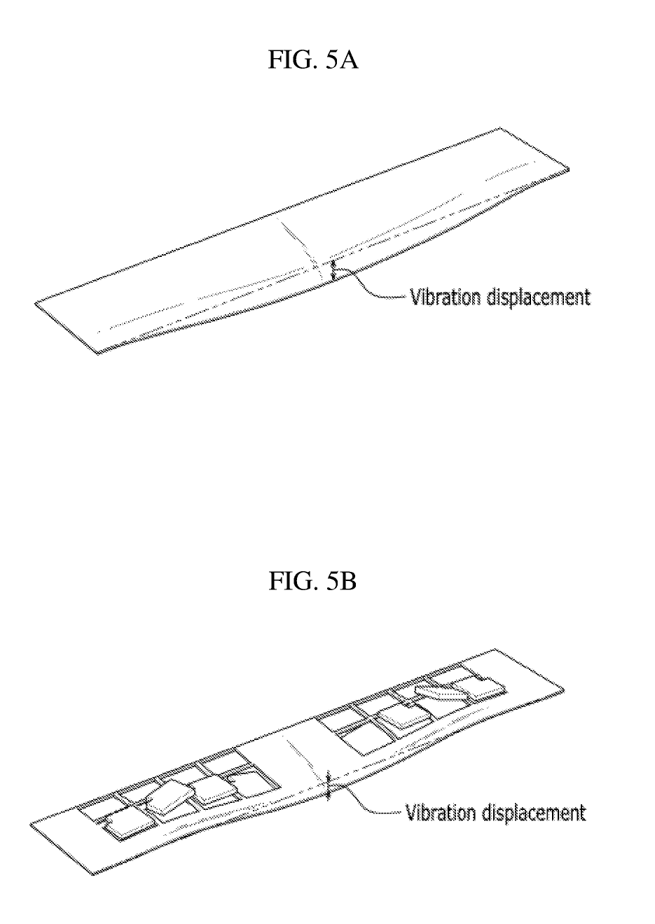

FIGS. 5A and 5B are an exemplary perspective view showing a noise reduction effect of a vibration reduction structure according to an exemplary embodiment of the present disclosure. FIG. 5A shows a tendency in which noise is generated around a panel without a vibration reduction structure and FIG. 5B shows vibration energy locally distributed and radiated noise is not transmitted far. According to an exemplary embodiment of the present disclosure, in FIGS. 5A and 5B, vibration displacement represented to show an effect of the vibration reduction structure may be exaggerated compared with actual vibration replacement.

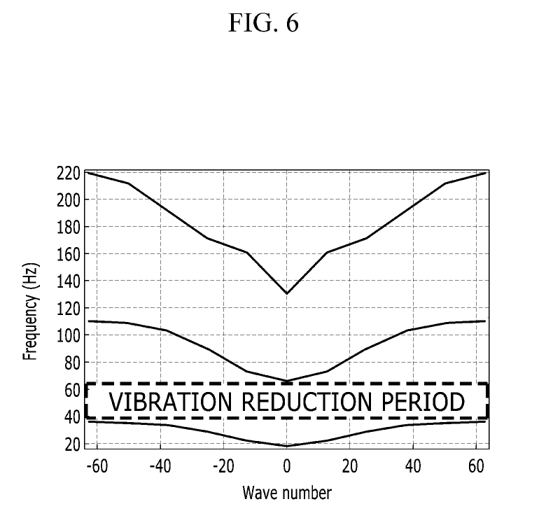

FIG. 6 is an exemplary graph showing a vibration reduction period in which a vibration reduction structure absorbs vibration according to an exemplary embodiment of the present disclosure. Referring to FIG. 6, a horizontal axis may indicate a wave number, a vertical axis may indicate a frequency, and a vibration reduction period may be a frequency of about 40 Hz to 50 Hz according to a design specification. For example, the vibration reduction period may be adjusted according to shape characteristics of the connecting member 130, the mass member 140, the main aperture 110, and the auxiliary aperture 120.

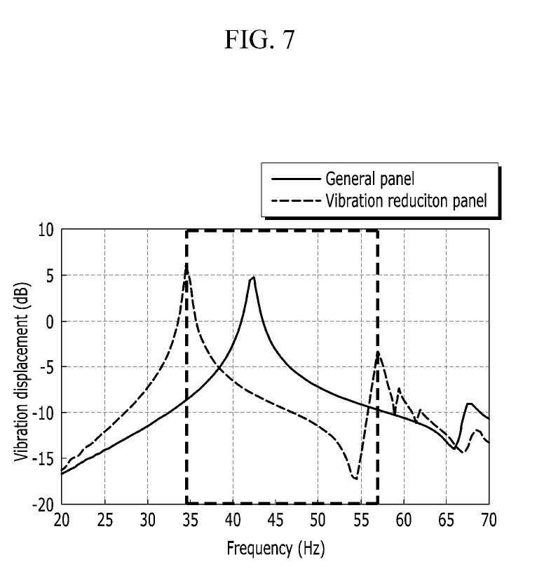

FIG. 7 is an exemplary graph showing a noise reduction effect of a vibration reduction structure according to an exemplary embodiment of the present disclosure. Referring to FIG. 7, a horizontal axis indicates a frequency and a vertical axis indicates vibration displacement. When a frequency is in a range of about 40 Hz to 55 Hz, vibration displacement may be mostly high in a general panel and vibration displacement may be mostly low in a noise reduction panel according to an exemplary embodiment of the present disclosure.

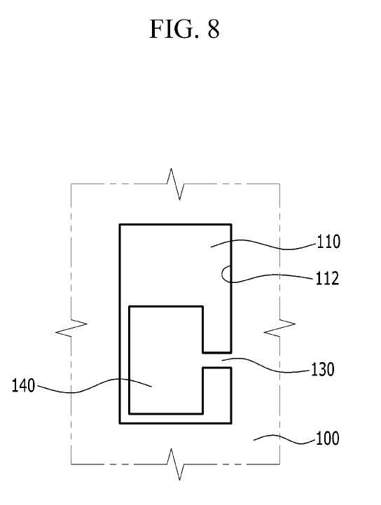

FIG. 8 is an exemplary top plan view showing a vibration reduction structure according to another exemplary embodiment of the present disclosure. Referring to FIG. 8, the main aperture 110 with a rectangular shape may be formed in a first side of the plate member 100, the mass member 140 may be disposed within the main aperture 110, and the connecting member 130 may be integrally formed with the plate member 100 and the mass member 140.

A thickness, width, and length of the connecting member 130 may be selected based on a frequency as a reduction target. Additionally, a length, width, and thickness of the mass member 140 may be selected according to a frequency as a reduction target. A width and length of the main aperture 110 may also be selected according to a frequency as a reduction target.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: place member
110: main aperture
112: first interior surface
120: auxiliary aperture
122: second interior surface
130: connecting member
140: mass member
150: sub gap

What is claimed is:

1. A vibration reduction structure, comprising:
a vibration reduction unit configured to reduce vibration or noise generated and transmitted to a plate member including a main aperture with a predetermined shape,
wherein the vibration reduction unit includes a mass member having a predetermined shape and a predetermined thickness and disposed in the main aperture and a connecting member configured to integrally couple the plate member and the mass member, and
wherein an area of the main aperture is greater than an area of the mass member.

2. The vibration reduction structure of claim 1, wherein a thickness of the plate member is equal to a thickness of the connecting member.

3. The vibration reduction structure of claim 1, wherein a thickness of the mass member is greater than a thickness of the plate member or the connecting member.

4. The vibration reduction structure of claim 1, wherein the plate member further includes an auxiliary aperture disposed adjacent to the main aperture.

5. The vibration reduction structure of claim 4, wherein the connecting member is inclined toward the auxiliary aperture from a virtual central line passing through a central portion of a aperture of the main aperture.

6. The vibration reduction structure of claim 1, wherein an edge of the mass member is disposed along a first interior surface of the plate member with the main aperture formed therein.

7. The vibration reduction structure of claim 1, wherein a sub gap with a predetermined length is formed between a lateral surface of the connecting member and a lateral surface of the mass member.

8. The vibration reduction structure of claim 1, wherein the vibration reduction unit is disposed on the plate with a predetermined interval.

9. The vibration reduction structure of claim 4, wherein the plurality of main apertures are disposed on the plate member with a predetermined interval and the auxiliary apertures are disposed on the plate member to correspond to the plurality of main apertures with a predetermined interval, respectively.

10. The vibration reduction structure of claim 4, wherein the main aperture and the auxiliary aperture have a quadrangular shape.

11. The vibration reduction structure of claim 1, wherein an external surface of the mass member facing a first interior surface of the plate member with the main aperture formed therein is formed with a predetermined gap.

12. The vibration reduction structure of claim 1, wherein the vibration reduction unit is disposed in a transmission direction of the vibration or noise.

13. The vibration reduction structure of claim 1, wherein the plate member is a roof panel of a vehicle body.

14. The vibration reduction structure of claim 1, wherein the plate member is a cowl or a cowl top panel disposed in a vehicle body.
